(19) United States
(12) Patent Application Publication
(10) Pub. No.: US 2002/0013225 A1
(43) Pub. Date: Jan. 31, 2002

(54) Thermally integrated monolith catalysts and processes for synthesis gas

(76) Inventors: Juan C. Figueroa, Wilmington, DE (US); Anne M. Gaffney, West Chester, PA (US); John E. Anderson, Avondale, PA (US); John J. Barnes, Hockessin, DE (US); Robert A. Oswald, Milton, DE (US); Roger Song, Wilmington, DE (US)

Correspondence Address: Joanna K. Payne, CONOCO INC., 1000 South Pine 2635 RW, P.O. Box 1267, Ponca City, OK, 74602-1267, US

(21) Appl. No.: 09/785,353

(22) Filed: Feb. 16, 2001

Related U.S. Application Data
(60) Provisional application No. 60/183,552, filed on Feb. 18, 2000.

(51) Int. Cl. C01B 31/18; B01J 23/74

(52) U.S. Cl. 502/302; 502/527.24; 502/303; 502/319; 502/338; 423/418.2; 423/651; 428/638; 428/613

(57) ABSTRACT

Thermally integrated monolith catalysts active for catalyzing the oxidative conversion of methane to CO and H₂ are disclosed. The composition and multi-layer configuration facilitates heat balancing between exothermic and endothermic reactions that take place in different sections of the monolith in a short contact time syngas reactor. The monolith comprises an active catalyst material supported by a multi-layer structure made of thin, porous metal pieces, the opposing faces of which are joined together at their perimeters. The metal pieces may be perforated disks made of at least two metals or metal oxides, and may also include a metal oxide coating.

### CROSS-REFERENCE TO RELATED APPLICATIONS

This application claims the benefit under 35 U.S.C. 119(e) of U.S. Provisional Application No. 60/183,552 filed Feb. 18, 2000. This application is related to co-pending U.S. patent application Ser. No. 09/626,894 filed Jul. 27, 2000.

### BACKGROUND OF THE INVENTION

1. Field of the Invention

The present invention relates to catalysts and processes for the catalytic conversion of light hydrocarbons (e.g., natural gas) employing a monolith catalyst to produce carbon monoxide and hydrogen (synthesis gas). More particularly, the invention relates to thermally integrated multi-layer monolith supported catalysts, their manner of making, and to processes employing the catalysts for production of synthesis gas.

2. Description of Related Art

Large quantities of methane, the main component of natural gas, are available in many areas of the world, and natural gas is predicted to outlast oil reserves by a significant margin. However, most natural gas is situated in areas that are geographically remote from population and industrial centers. The costs of compression, transportation, and storage make its use economically unattractive.

To improve the economics of natural gas use, much research has focused on methane as a starting material for the production of higher hydrocarbons and hydrocarbon liquids. The conversion of methane to hydrocarbons is typically carried out in two steps. In the first step, methane is reformed with water to produce carbon monoxide and hydrogen (i.e., synthesis gas or syngas). In a second step, the syngas is converted to hydrocarbons.

Current industrial use of methane as a chemical feedstock proceeds by the initial conversion of methane to carbon monoxide and hydrogen by either steam reforming, which is the most widespread process, or by dry reforming. Steam reforming currently is the major process used commercially for the conversion of methane to synthesis gas, proceeding according to Equation 1.

CH₄+H₂O [symbol] CO+3H₂ (1)

Although steam reforming has been practiced for over five decades, efforts to improve the energy efficiency and reduce the capital investment required for this technology continue.

The catalytic partial oxidation of hydrocarbons, e.g., natural gas or methane to syngas is also a process known in the art. While currently limited as an industrial process, partial oxidation has recently attracted much attention due to significant inherent advantages, such as the fact that significant heat is released during the process, in contrast to steam reforming processes.

In catalytic partial oxidation, natural gas is mixed with air, oxygen-enriched air, or oxygen, and introduced to a catalyst at elevated temperature and pressure. The partial oxidation of methane yields a syngas mixture with a H₂:CO ratio of 2:1, as shown in Equation 2.

CH₄+1/2O₂ [symbol] CO+2H₂ (2)

This ratio is more useful than the H₂:CO ratio from steam reforming for the downstream conversion of the syngas to chemicals such as methanol and to fuels. The partial oxidation is also exothermic, while the steam reforming reaction is strongly endothermic. Furthermore, oxidation reactions are typically much faster than reforming reactions. This allows the use of much smaller reactors for catalytic partial oxidation processes. The syngas in turn may be converted to hydrocarbon products, for example, fuels boiling in the middle distillate range, such as kerosene and diesel fuel, and hydrocarbon waxes by processes such as the Fischer-Tropsch Synthesis.

The selectivities of catalytic partial oxidation to the desired products, carbon monoxide and hydrogen, are controlled by several factors, but one of the most important of these factors is the choice of catalyst composition. Difficulties have arisen in the prior art in making such a choice economical. Typically, catalyst compositions have included precious metals and/or rare earths. The large volumes of expensive catalysts needed by prior art catalytic partial oxidation processes have placed these processes generally outside the limits of economic justification.

For successful operation at commercial scale, the catalytic partial oxidation process must be able to achieve a high conversion of the methane feedstock at high gas hourly space velocities, and the selectivity of the process to the desired products of carbon monoxide and hydrogen must be high. Such high gas hourly space velocities are difficult to achieve at reasonable gas pressure drops, particularly with fixed beds of catalyst particles. Accordingly, substantial effort has been devoted in the art to the development of catalyst support structures and the design of the catalytic reaction zone.

Fixed reaction zone processes, wherein the reaction zone comprises a fixed bed of solid catalyst particles, have been known for some time and are described in the patent literature. For example, U.S. Pat. No. 5,149,464 describes such a process and catalyst. A number of other process regimes have been proposed in the art for the production of syngas via partial oxidation reactions. For example, the process described in U.S. Pat. No. 4,877,550 employs a syngas generation process using a fluidized reaction zone. Such a process however, requires downstream separation equipment to recover entrained supported-nickel catalyst particles.

To overcome the relatively high pressure drop associated with gas flow through a fixed bed of catalyst particles, which can prevent operation at the high gas space velocities required, various structures for supporting the active catalyst in the reaction zone have been proposed. U.S. Pat. No. 5,510,056 discloses a monolithic support such as a ceramic foam or fixed catalyst bed having a specified tortuosity and number of interstitial pores that is said to allow operation at high gas space velocity. Suggested catalysts are ruthenium, rhodium, palladium, osmium, iridium, and platinum. Data are presented for a ceramic foam supported rhodium catalyst at a rhodium loading of from 0.5-5.0 wt %.

U.S. Pat. No. 5,648,582 also discloses a process for the catalytic partial oxidation of a feed gas mixture consisting essentially of methane. The methane-containing feed gas mixture and an oxygen-containing gas are passed over an alumina foam supported metal catalyst at space velocities of 120,000 hr.⁻¹ to 12,000,000 hr.⁻¹ The catalytic metals exemplified are rhodium and platinum, at a loading of about 10 wt %.

As mentioned above, the partial oxidation of methane is a very exothermic reaction, and at typical reaction conditions temperatures in excess of 1000° C. may be required for successful operation. Conventional ceramic monolith catalyst supports are susceptible to thermal shock, i.e., either rapid changes in temperature with time or substantial thermal gradients across the catalyst structure. Catalysts and catalyst supports for use in such a process must therefore be very robust, and avoid structural and chemical breakdown under the relatively extreme conditions prevailing in the reaction zone.

U.S. Pat. No. 5,639,401 discloses a porous monolithic foam catalyst support of relatively high tortuosity and porosity, that contains at least 90 wt % zirconia for thermal shock resistance. The catalytically active components exemplified are rhodium and iridium, at a catalyst loading of 5 wt %.

The complete oxidation of hydrocarbons, which occurs in automobile catalytic converters, also requires a catalyst that functions at high space velocities and is stable at elevated temperatures greater than about 700° C. U.S. Pat. No. 5,511,972 discloses a catalyst structure that is effective under the severe conditions encountered in automobile catalytic converters. The catalyst structure comprises a ferrous alloy as the catalyst support. The ferrous alloy contains aluminum, which forms micro-crystals or whiskers of alpha-alumina on the alloy surface when heated in air. A washcoat of gamma-alumina is added to the alpha-alumina surface followed by the deposition of palladium.

As disclosed by Czech, et al., in Surface and Coatings Technology, 108-109 (1998) p. 36-42, stationary gas turbine engines for electric power generation operate at gas inlet temperatures that are as high as those in the catalytic partial oxidation reaction zone. The turbine blades are subjected to very high thermal and mechanical loads and are additionally attacked by oxidation. To deal with the mechanical loads, the base material of the turbine blades is metallic in composition. To deal with the thermal and chemical stresses, the turbine blades have a coating with a composition represented by MCrAlY, where M comprises Ni and/or Co, as a protective overlay coating against oxidation. Additional coatings may be added as thermal barriers. The overlay coatings are typically applied by either Low Pressure Plasma Spray or Vacuum Plasma Spray. The base material is protected in operation by an alumina scale, which forms from the overlay coating.

Piga et al. (Natural Gas Conversion V, Studies in Surface Science and Catalysis, Vol. 119, pp. 411-416 (1998) Elsevier Science V.B.) describes a heat-integrated wall reactor used for synthesis gas formation by catalytic partial oxidation of methane.

U.S. Pat. No. 5,858,314 and PCT Published App. No. WO97/39490 (each assigned to Ztek Corporation) describe a natural gas reformer comprising a stack of thermally conducting plates interspersed with catalyst plates and provided with internal or external manifolds for reactants. The catalyst plate is in intimate thermal contact with the conducting plates so that its temperature closely tracks the temperature of the thermally conducting plate.

A major drawback of many catalysts designed for catalyzing the partial oxidation of methane to syngas is the catastrophic failure of monolith supports exposed to severe exothermic reactions localized in certain regions of the monolith. Although ceramic monoliths may have the required high melting temperature to sustain such exotherms, they typically suffer from structural failure due to thermal shock. Accordingly, there is a continuing need for better supported catalysts and processes for the catalytic conversion of light hydrocarbons such as methane, to syngas. Such improved processes should provide, by a predominantly partial oxidation reaction, high conversions of methane and high selectivities to CO and H₂ products. This requires a catalyst that possesses good thermal and mechanical stability, and yet is highly porous, permitting low pressure drop for use in a short contact time reactor. In order for such a process to be economical for industrial scale operation, large quantities of rare or expensive catalyst components should be avoided.

### SUMMARY OF THE INVENTION

The present invention overcomes many of the deficiencies of existing catalysts and processes for converting a light hydrocarbon feedstock to synthesis gas. Porous multi-layer monolith catalysts that provide thermal integration within the monolith are provided, together with their manner of making. The term “thermal integration” means that these monolith catalyst structures and supports contain thermally conductive portions that facilitate heat balancing between the exothermic and endothermic reactions that take place in different sections within the monolith, as occurs, for example, when used on-stream in a syngas production reactor. In preferred embodiments, the multi-layer catalysts comprise an active catalyst material supported by a multi-disk structure. Each disk may be made of perforated metal and joined to adjacent disks in a stack by one or more thermally conductive connections or junctions, capable of transferring heat from one portion of the stack to an adjacent portion. In certain embodiments the metal is an oxide-dispersion-strengthened (ODS) alloy comprising iron and/or nickel and/or cobalt, aluminum, chromium, and yttrium oxide, such as PM2000™. In certain other embodiments the monolith comprises an alloyed bulk metal substrate such as a perforated Ni disk alloyed with Cr and/or Co.

Certain multi-layer monolith catalysts in accordance with the invention comprise an alumina coated stack of thin, porous metal layers or disks which have been fixed together in such a way that the resulting multi-disk monolith is strong while maintaining high porosity for each disk and enhanced thermal conduction between layers. For example, adjacent perimeters of facing disks may be spot welded together via a thermally conductive weld. A catalytically active component is supported on the multi-layer monolith.

Also provided by the invention are multi-layer supports for active catalyst materials, the supports comprises a stack of porous, thin metal pieces, such as perforated metal disks, with the top and bottom faces of each piece affixed, respectively, to opposing top or bottom faces of adjacent pieces. The pieces are joined at their peripheries by at least one thermally conductive junction, such as a spot weld.

Also provided by the invention are processes for producing CO and H₂ from light hydrocarbon feedstocks by a net catalytic partial oxidation reaction, employing a catalytically effective amount of one of the new thermally integrated monolith catalysts. The processes comprise contacting a feed stream comprising a C₁-C₅ hydrocarbon feedstock and an oxygen-containing gas with one of the above-described thermally integrated monolith catalysts in a reaction zone maintained at conversion-promoting conditions of reaction zone temperature, reactant gas composition, space velocity and pressure, effective to produce an effluent stream comprising carbon monoxide and hydrogen. In preferred embodiments the catalyst/reactant gas contact time in the reaction zone of the reactor is no more than about 10 milliseconds. In preferred embodiments the hydrocarbon feedstock comprises a methane to oxygen molar ratio of about 1.5:1 to about 2.2:1. In certain embodiments the process comprises contacting the reactant gas mixture with the catalyst at a temperature of about 600-1300° C., preferably about 800-1,200° C. and a pressure of about 850-3000 kPa. Some embodiments of the process include preheating the reactant gas mixture to a temperature of about 50-700° C.

These and other embodiments, features and advantages of the present invention will become apparent with reference to the following description.

### DETAILED DESCRIPTION OF PREFERRED EMBODIMENTS

In the following examples, multi-layer structures comprising a stack of thin, circular perforated metal disks joined together by a thermally conductive connection, and, optionally, coated with an oxidation barrier, serve as thermal shock resistant catalyst supports for active metal catalyst materials that are highly active for catalyzing the production of syngas from methane.

In general, the catalyst preparation includes fabricating a stack of thin, circular perforated metal disks joined together by a thermally conductive connection; scaling the multi-disk structure at a high temperature for sufficient time to grow an alumina layer; impregnating the multi-layer structure with active catalyst precursor material; drying and calcining the resulting monolith catalyst. The multi-layer structure is scaled, or pretreated, by heating in air or oxygen at 900° C. to 1200° C., preferably 1100° C., for a period of time ranging from about 10-100 hours, preferably 50 hours, to form a thin, tightly adhering oxide surface layer which protects the underlying support alloy from further oxidation during high temperature use. The surface layer also functions as a diffusion barrier to the supported metal catalyst, thus preventing alloying of the catalyst metal with the alloy of the catalyst support. For example, the protective surface layer may be composed predominantly of alpha-alumina, but also contain a small amount of yttrium oxide.

After pretreatment, the multi-layer support structure is coated with a catalyst metal, or catalyst precursor material, selected from the group consisting of Rh, Ni, Co, Al, Pt, Ru, Ir, Re and combinations thereof, preferably Rh and Ni or Co and Al. The coating may be achieved by any of a variety of methods known in the art, such as physical vapor deposition, chemical vapor deposition, electrolysis metal deposition, electroplating, melt impregnation, and chemical salt impregnation. When rhodium is included in the composition, a final reduction step is included.

### EXAMPLE 1

1.42% Rh—Ni/PM2000 Monolith (unpolished)

A 0.010″ sheet of an oxide-dispersion-strengthened (ODS) alloy steel, PM2000™ (commercially available from Schwartzkopf Technologies, Franklin, Mass.), was used to fabricate perforated circular disks, each about 12 mm in diameter. One hundred seventeen (117) nominally square perforations measuring about 0.023×0.023″, and located on a 28.5-mesh square grid pattern (0.035″ center-to-center distance), were photoetched through each of the disks to serve as gas passages. PM2000™ has the following approximate composition: 75 wt % Fe, 19 wt % Cr, 5.5 wt % Al, and 0.5 wt % Y₂O₃. Thirty (30) perforated disks were stacked and welded at their adjacent peripheries to form a multi-layer structure, or monolith, with dimensions of 0.3″×12 mm O.D. The disk diameter of 12 mm was chosen for compatibility with the 13 mm inner diameter of the particular quartz reactor used for testing the performance characteristics of one or more multi-disk catalysts, as described in the section entitled “Test Procedure.”

The multi-disk structure was scaled at a high temperature for sufficient time to grow an alumina layer. More particularly, the scaling process consisted of pretreating the multi-disk structure by exposure to pure oxygen for 50 hours at a temperature of approximately 1100° C. After pretreatment, a scale comprising alpha-alumina was observed on the surface of the disks by X-ray diffraction (Energy Dispersive Analysis of X-rays) (EDAX) and scanning electron microscopy methods. The thickness of the alpha-alumina scale was measured by weight change and cross-sectional metallography at approximately 3 μm. This was confirmed by optical metallography and (SEM) methods. The α-alumina (surface) conversion coating renders the multi-disk structure highly oxidation resistant and also facilitates attachment of the active catalyst precursor to the multi-disk support structure, as described below.

Impregnation of the multi-layer structure with an active catalyst precursor solution was carried out as follows: In a 50 mL Teflon beaker, RhCl₃.3H₂O (0.1148 g) and Ni(NO₃)₂′6H₂O (1.3338 g) were dissolved in 0.8 mL of water and the multi-disk structure (4.1736 g) was immersed into the solution. After evaporating off the solvent at room temperature overnight, the monolith was further dried in a vacuum oven at 110° C. for 2 hours, calcined in air at 600° C. for 1 hour, and reduced at 600° C. for 4 hours with 10 mL/min H₂ and 90 mL/min N₂. Some black powder was recovered after calcination indicating that only a portion of the Rh and Ni was deposited onto the multi-disk support structure. The Rh—Ni metal loading of the resulting monolith catalyst was determined to be 1.42% Rh—Ni (mole % of total metal content; (atomic ratio of Rh:Ni=1:10)). The monolith catalyst was charged to the reactor for testing according to the “Test Procedure.” The catalyst performance is shown in Tables 2 and 3.

### EXAMPLE 2

1.72% Rh—Ni/PM2000 Monolith (polished)

A 1.72% (mole % of total metal content) Rh—Ni loaded monolith (Rh:Ni=1:10) was made of 30 polished PM2000™ disks, substantially as described in Example 1, except in the present case polished disks were used instead of unpolished disks. The differences in the wt % loadings for the monoliths of Examples 1 and 2 was, therefore, largely due to the physical differences between the polished and unpolished substrate disks. For example, the act of polishing reduced the amount of residual metal (i.e., an unpolished monolith (4.1736 g) was heavier than the corresponding polished monolith (3.6778 g). Other effects of polishing could further influence the amount of catalyst that adhered to the surface. With either polished or unpolished substrates, it was observed throughout these studies that good reproducibility in metal loading of the monoliths was obtained when the same techniques were employed. The monolith catalyst was charged to the reactor for testing according to the “Test Procedure.” The catalyst performance is shown in Tables 2 and 3.

### EXAMPLE 3

1.82% (Co/Al)/PM2000 Monolith

Thirty polished PM2000™ disks were spot welded to form a thermally integrated multi-disk structure with dimension of 7×12 mm O.D, as described in Example 1. The structure was scaled at 1100° C. for 50 hours to grow an alumina layer, as previously described, and then Co and Al with 1:2 atomic ratio were deposited by the following impregnation procedure:

In a 25 mL Teflon beaker, Al(NO₃)₃.9H₂O (1.2466 g ) and Co(NO₃)₂.6H2O (0.4835 g) were dissolved in 1 mL of water. The monolith (3.5247 g) was immersed into the solution. After evaporating off the solvent at room temperature overnight, the monolith was dried in a vacuum oven at 110° C. for 2 hours and calcined at 400° C. for 2 hours. Some black powder was recovered after calcination indicating that only a portion of the Co and Al was deposited onto the monolith. The Co—Al metal loading of the resulting monolith catalyst was determined to be 1.82 % Co—Al (mole % of total metal content; (atomic ratio of Co:Al=1:2)). The monolith catalyst was charged to the reactor for testing according to the “Test Procedure.” The catalyst performance is shown in Tables 2 and 4.

### EXAMPLE 4

2.3% Co/PM2000 Monolith

The preparation and scaling of the monolith, using polished PM2000™ disks, was the same as that in Example 1. The Co was deposited onto the monolith by the following procedure:

In a 25 mL of Teflon beaker, Co(NO₃)₂.6H₂O(1.1139 g) was dissolved in 1 mL of water. The monolith (3.5335 g) was immersed into the solution. After evaporating off the solvent at room temperature overnight, the monolith was dried in a vacuum oven at 110° C. for 2 hours and calcined at 400° C. for 2 hours. Some black powder was recovered after calcination indicating that only a portion of the Co was deposited onto the monolith. Co metal loading of the resulting monolith catalyst was determined to be 2.3% Co (mole % of total metal content).

The foregoing representative multi-layer monolith catalysts were prepared using PM2000™, however suitable supports can also be prepared from other high temperature oxidation-resistant, aluminum-containing oxide-dispersion-strengthened (“ODS”) alloys. These alloys contain a dispersion of an oxide, such as Y₂O₃. Oxide particles serve to strengthen the alloy and promote the formation of a compact, tenacious, oxide layer on the alloy surface when properly treated, as described above. One alternative ODS alloy for use as a thermally integrated catalyst support consists of, by weight, 15 to 25% chromium (Cr), 3 to 6% aluminum (Al), 0.1 to 1.0% titanium (Ti), 0.1 to 1.0% Y₂O₃ and the balance iron (Fe). Fe-based ODS alloys such as this are readily commercially available. Other suitable ODS alloys for making multi-layer thermally integrated monoliths are the Ni-base ODS alloys and Co-base alloys. Fe-base or Ni-base or Co-base alloys that do not contain an oxide dispersion but contain Cr and Al can also be satisfactorily used for forming satisfactory multi-layer support structures for the thermally integrated monolith catalysts. One preferred alloy of non-ODS composition consists of, by weight, 15 to 25% chromium (Cr), 3 to 6% aluminum (Al), 0.1 to 1.0% titanium (Ti), 0.3 to 1.0% yttrium, lanthanum or scandium (Y, La or Sc), and the balance iron (Fe) or nickel (Ni) or cobalt (Co). The monolith catalyst was charged to the reactor for testing according to the “Test Procedure.” The catalyst performance is shown in Tables 2 and 4. As demonstrated in the following Examples, representative thermally integrated monoliths were also prepared from non-ODS substrate materials such as bulk Ni alloys.

### EXAMPLE 5

Ni—Cr Thermally Integrated Catalyst

A thermally integrated Ni—Cr alloy monolith catalyst was prepared from perforated Ni foil substrates which were perforated by photofabrication. The substrate disks were 12 mm O.D., 0.025 mm thick, with square perforations with a 0.295 mm side, located on a 60-mesh square grid. Alternatively, another perforation technique such as abrasive drilling, laser drilling, electron beam drilling, electric discharge machining, stretching of a slitted foil, or another well known technique described in the literature could be used to perforate the disks.

A chromium coating was deposited onto one side or face of a perforated Ni substrate using a physical vapor deposition system. The perforated nickel substrate was in the form of a 12 mm diameter×0.004 inch (0.1016 mm) thick disk. A number of these substrate disks were processed at the same time. The vapor deposition system comprised a stainless chamber (initially cryopumped down to a base pressure in the low 10⁻⁶ Torr range), a vertically oriented rotating cylindrical substrate holder and a set of magnetron sputter vaporization sources located around the holder at different axial heights. This reactor design is suitable for the combinatorial synthesis of a multitude of coating compositions in a single pumpdown. In this test, several expanded Ni metal disks (each about 12 mm in diameter and 0.1016 mm thick), were treated as follows: (a) the substrates were wiped with a lint-free acetone-impregnated cloth and introduced to the vapor deposition chamber (b) after attainment of base pressure, the chamber was back filled with flowing oxygen kept at 20 mTorr, (c) the substrate holder was RF glow discharge ignited at 13.56 MHz with a bias voltage of 175 volts for 15 minutes, (d) the flowing as was switched from oxygen to argon and the substrate holder was set in motion at 5 rpm, (e) the Cr magnetron vaporization source was ignited with a DC power supply for a period of time necessary to achieve a given coating thickness distribution. Such thickness distribution is determined by the targeted stoichiometry of the bulk catalyst, which is governed by the relative masses of substrate and coating. Alternatively, the Ni substrates can be coated with chromium metal using techniques such as electrolytic deposition, electroless deposition, thermal spraying, chemical vapor deposition, and other processes that are well-known and have been described in several references, such as Handbook of Thin Film Technology, L. Maissel and R. Glang (eds.), McGraw-Hill (1970), or Thin Film Processes, J. A. Thornton and W. Kern (eds.), Academic Press (1978).

The disks were spot welded into disk paks of up to twenty (with all disks in the welded pak having the same Cr:Ni atomic stoichiometric ratio), and subsequently diffusion treated in Ar—H₂ at 1000 C. for 4 hours. The high temperature treatment in a non-oxidizing environment effected the solid state interdiffusion between the coating and the Ni substrate. As a result, the chromium became diffused into the Ni substrate atomic lattice to produce a bulk Ni—Cr alloy catalyst, in the form of a perforated foil disk that was compositionally homogenized across its thickness. Eight disk-paks were stacked together to yield a bed having a decreasing Cr concentration, from feed entry to product exit, as indicated in Table 5. The eighth disk-pak had no Cr coating and was not exposed to the diffusion treatment. The total bed height was 6 mm. The bulk Ni—Cr perforated metal disks were charged to the reactor for testing, as described in the section entitled “Test Procedure.” The catalyst performance is shown in Table 7.

### EXAMPLE 6

Ni—Co—Cr Thermally Integrated Catalyst

A bulk Ni—Co—Cr alloy catalyst was prepared from a perforated Ni foil substrate disk as described in Example 5, except that chromium and cobalt metals were simultaneously deposited onto the nickel substrate disks. Cr and Co magnetron vaporization sources were ignited with separate DC power supplies for a period of time necessary to achieve a given coating thickness distribution. The Co—Cr coated disks were spot welded into disk paks of up to twenty disks (with all disks in the welded pak having the same Cr:Co:Ni atomic stoichiometric ratio), and subsequently diffusion treated in Ar—H₂ at 1000° C. for 4 hours, to form disks that were compositionally homogenized across their thickness, as described above. Eight disk-paks were stacked together to yield a bed having a decreasing CoCr concentration, from feed entry to product exit, as indicated in Table 6. The eighth disk-pak had no Cr coating and was not exposed to the diffusion treatment. The total bed height was 6 mm. The bulk Ni—Cr perforated metal disk-paks were charged to the reactor for testing, as described in the section entitled “Test Procedure.” The catalyst performance is shown in Table 7.

Test Procedure

Representative thermally integrated multi-layer monolith catalysts prepared according the foregoing Examples were tested for their catalytic activity and physical durability in a reduced scale syngas production reactor. The catalytic oxidation of methane was performed with a conventional flow apparatus using a 19 mm O.D.×13 mm I.D. and 12″ long quartz reactor. A ceramic foam of 99% Al₂O₃ (12 mm OD×5 mm of 45 ppi) was placed before and after the catalyst as radiation shields. The inlet radiation shield also aided in uniform distribution of the feed gases. An Inconel® sheathed, single point K-type (Chromel/Alumel) thermocouple (TC) was placed axially inside the reactor touching the top (inlet) face of the radiation shield. A high temperature S-Type (Pt/Pt 10% Rh) bare-wire TC was positioned axially touching the bottom face of the catalyst and was used to indicate the reaction temperature. The monolith catalyst and the two radiation shields were sealed tight against the walls of the quartz reactor by wrapping them radially with a high purity (99.5%) alumina paper. A 600 watt band heater set at 90% electrical output was placed around the quartz tube, providing heat to light off the reaction and to preheat the feed gases. The bottom of the band heater corresponded to the top of the upper radiation shield.

In addition to the TCs placed above and below the catalyst, the reactor also contained two axially positioned, triple-point TCs, one before and another after the catalyst. These triple-point thermocouples were used to determine the temperature profiles of reactants and products subjected to preheating and quenching, respectively.

Unless noted otherwise, all runs were done at a CH₄:O₂ molar ratio of 2:1 with a combined flow rate of 7.7 standard liters per minute (SLPM) (431,720 GHSV) and at a pressure of 5 psig (136 kPa). The reactor effluent was analyzed for CH₄, O₂, CO, H₂, CO₂, and N₂ using a gas chromatograph equipped with a thermal conductivity detector. The C, H and O mass balance were all between 98% and 102%. The results of the reactions catalyzing the oxidative conversion of methane by various representative monolith catalysts are shown in the following tables. Gas hourly space velocity is indicated in Table 2 by “GHSV”. The GHSV is calculated according to the equation: GHSV=Fₜₒₜ/V_{cat}, where Fₜₒₜ is the total reactant volumetric flow rate in cm³/sec, and V_{cat} is the volume of the catalyst reaction zone total reactant flow rate at standard conditions/volume of catalyst reaction zone in cm³. For ease in comparison with prior art systems, space velocities at standard conditions have been used to describe in the present studies. It is well recognized in the art, however, that residence time is the inverse of space velocity, and that the disclosure of high space velocities equates to low residence times on the catalyst.

The catalyst compositions (expressed as atomic ratios) and metal loading (mole % of total metal content) for the ODS (PM2000) monolith supported catalysts are shown in Table 1. The run conditions and results when these catalysts were evaluated as described in the section entitled “Test Procedure” are shown in Table 2. Table 2 reports the temperature conditions, feedstock conversion, product selectivities, gas hourly space velocities, and molar ratios of the reactant and product gases for each catalyst. The Rh—Ni monolith made of polished disks demonstrated no enhancement of activity over the Rh—Ni monolith made of the more economical unpolished disks in these tests.

TABLE 1
PM 2000 Monolith Supported Catalysts

| Example No. | Catalyst No. | Composition |
|---|---|---|
| 1 | 233 | 1.42% Rh-Ni (Rh:Ni = 1:10) |
| | 234 | 0.34% (Ni_{0.2} Cr_{0.8}) |
| | 235 | 0.42% (Co_{0.2} Cr_{0.8}) |
| 3 | 236 | 1.82% Co-Al (Co:Al = 1:2) |
| 2 | 237 | 1.72% Rh-Ni (Rh:Ni = 1:10) |
| 4 | 238 | 2.31% Co |
| | 239 | 0.46% (Ni_{0.1} Co_{0.1} Cr_{0.8}) |

Monolith made of unpolished disks

TABLE 2
Run conditions and Catalyst Performance

| | | | | | | % CH₄/ | | | |
|---|---|---|---|---|---|---|---|---|---|
| Example | Catalyst | Preheat | | Temp. | | O₂ | % CO | % H₂ | |
| No. | No. | (° C.) | CH₄:O₂ | (° C.) | SLPM | (Conv.) | (Sel.) | (Sel.) | H₂:CO |
| 1 | 233 | 517 | 2:1 | 866 | 2.5 | 79/100 | 95 | 93 | 1.96 |
| | 234 | crashed on over temp. | | | | | | | |
| | 235 | crashed on over temp. | | | | | | | |
| 3 | 236 | 520 | 2:1 | 899 | 2.5 | 77/98 | 96 | 92 | 1.92 |
| | | 484 | 2:1 | 1002 | 5.0 | 79/98 | 97 | 91 | 1.88 |
| 2 | 237 | 499 | 2:1 | 947 | 2.5 | 78/100 | 93 | 88 | 1.89 |
| 4 | 238 | 510 | 2:1 | 1169 | 2.5 | 44/100 | 81 | 61 | 1.51 |

| | |
|---|---|
| 239 | crashed on over temp. |

Table 3 shows the catalyst performance data for representative thermally integrated rhodium-nickel multi-disk monolith supported catalysts. Table 4 shows the performance of cobalt and Co—Al multi-disk monolith supported catalysts. The Rh—Ni, and Co—Al multi-disk -monolith supported catalysts all gave at least 77% CH₄ conversion and selectivities for CO and H₂ products of at least 88%. The H₂:CO ratio indicates that the net partial oxidation of methane occurred and/or the predominant reaction was the catalytic oxidation of methane.

In the present studies, it was observed that the metallic nature of the thermally integrated multi-disk monolith catalysts improves the thermal conduction and thermal shock resistance of the catalyst, compared to conventional nickel catalysts supported on ceramic substrates. Attachment of each disk in the stack to adjacent disks by spot welding portions of their peripheries together, before scaling, maximizes the thermal conductivity of the multi-disk monolith, without severely reducing the porosity of the structure.

TABLE 3
Catalyst Performance
Rh—Ni PM2000 Monolith Supported Catalysts

| | CH₄:O₂ | Preheat | Catal. Temp. | % CH₄ | % O₂ | % CO | % H₂ | H₂:CO |
|---|---|---|---|---|---|---|---|---|
| Ex. | Ratio | (° C.) | (° C.) | Conv. | Conv. | Sel. | Sel. | Ratio |
| 1 | 2:1 | 517 | 866 | 79 | 100 | 95 | 93 | 1.96 |
| 2 | 2:1 | 499 | 953 | 78 | 100 | 95 | 88 | 1.85 |

Feed: 60% CH₄, 30% O₂, 10% N₂

TABLE 4
Catalyst Performance
Co and Co-Al/PM2000 Monolith Supported Catalysts

| | CH₄:O₂ | Preheat | Catal. Temp. | % CH₄ | % O₂ | % CO | % H₂ | H₂:CO |
|---|---|---|---|---|---|---|---|---|
| Ex. | Ratio | (° C.) | (° C.) | Conv. | Conv. | Sel. | Sel. | Ratio |
| 3 | 2:1 | 520 | 899 | 77 | 98 | 96 | 92 | 1.92 |
| 3 | 2:1 | 546 | 911 | 79 | 99 | 96 | 93 | 1.94 |
| 4 | 2:1 | 510 | 1169 | 44 | 100 | 81 | 61 | 1.51 |

Feed: 60% CH₄, 30% O₂, 10% N₂

TABLE 5
Composition of Ni-Cr Paks*

| Pak Order | Atomic % Cr |
|---|---|
| 1 | 14.5 |
| 2 | 10.1 |
| 3 | 10.9 |
| 4 | 3.7 |
| 5 | 4.2 |
| 6 | 0.8 |
| 7 | 1.1 |
| 8 | 0.0 |

*determined by Inductive Coupled Plasma Spectroscopy

TABLE 6
Composition of Ni-Co-Cr Paks*

| Pak Order | Atomic % Cr | Atomic % Co |
|---|---|---|
| 1 | 11.4 | 3.1 |
| 2 | 7.5 | 1.9 |
| 3 | 8.6 | 2.1 |
| 4 | 2.1 | 0.5 |
| 5 | 2.4 | 0.5 |
| 6 | 0.6 | 0.1 |
| 7 | 0.8 | 0.1 |
| 8 | 0.0 | 0.0 |

*determined by Inductive Coupled Plasma Spectroscopy

TABLE 7
Catalyst Performance
Ni—Cr and Ni—Co—Cr/Ni Foil Monolith Supported Catalysts

| Example | CH₄:O₂ | Catal. Temp. | % CH₄ | % O₂ | % CO | % H₂ | H₂:CO |
|---|---|---|---|---|---|---|---|
| No. | Ratio | (° C.) | Conv. | Conv. | Sel. | Sel. | Ratio |
| 5 | 2:1 | 820 | 77 | 100 | 99 | 92 | 1.86 |
| 6 | 2:1 | 820 | 82 | 100 | 99 | 96 | 1.94 |

Feed: 60% CH₄, 30% O₂, 10% N₂; Flow rate 7.5 SLPM

Process of Producing Syngas

A feed stream comprising a light hydrocarbon feedstock, such as methane, and an oxygen-containing gas is contacted with a catalyst bed containing one or more thermally integrated multi-layer monolith catalysts prepared substantially as described in one of the foregoing Examples. The monoliths comprising the catalyst bed are favorably arranged in a reaction zone maintained at conversion-promoting conditions effective to produce an effluent stream comprising carbon monoxide and hydrogen. Preferably a millisecond contact time reactor is employed, equipped for either axial or radial flow of reactant and product gases.

Several schemes for carrying out catalytic partial oxidation (CPOX) of hydrocarbons in a short or millisecond contact time reactor have been described in the literature. For example, L. D. Schmidt and his colleagues at the University of Minnesota describe a millisecond contact time reactor in U.S. Pat. No. 5,648,582 and in J. Catalysis 138, 267-282 (1992) for use in the production of synthesis gas by direct oxidation of methane over a catalyst such as platinum or rhodium. A general description of major considerations involved in operating a reactor using millisecond contact times is given in U.S. Pat. No. 5,654,491. The disclosures of the above-mentioned references are incorporated herein by reference.

The hydrocarbon feedstock may be any gaseous hydrocarbon having a low boiling point, such as methane, natural gas, associated gas, or other sources of light hydrocarbons having from 1 to 5 carbon atoms. The hydrocarbon feedstock may be a gas arising from naturally occurring reserves of methane which contain carbon dioxide. Preferably, the feed comprises at least 50% by volume methane, more preferably at least 75% by volume, and most preferably at least 80% by volume methane.

The hydrocarbon feedstock is in the gaseous phase when contacting the catalyst. The hydrocarbon feedstock is contacted with the catalyst as a mixture with an oxygen-containing gas, preferably pure oxygen. The oxygen-containing gas may also comprise steam and/or CO₂ in addition to oxygen. Alternatively, the hydrocarbon feedstock is contacted with the catalyst as a mixture with a gas comprising steam and/or CO₂. It is preferred that the methane-containing feed and the oxygen-containing gas are mixed in such amounts to give a carbon (i.e., carbon in methane) to oxygen (i.e., oxygen) ratio from about 1.25:1 to about 3.3:1, more preferably, from about 1.3:1 to about 2.2:1, and most preferably from about 1.5:1 to about 2.2:1, especially the stoichiometric ratio of 2:1. The process is operated at atmospheric or superatmospheric pressures, the latter being preferred. The pressures may be from about 100 kPa to about 12,500 kPa, preferably from about 130 kPa to about 10,000 kPa. The process is preferably operated at temperatures of from about 600° C. to about 1300° C., preferably from about 800° C. to about 1,200° C. The hydrocarbon feedstock and the oxygen-containing gas are preferably pre-heated before contact with the catalyst. The hydrocarbon feedstock and the oxygen-containing gas are passed over the catalyst at any of a variety of space velocities sufficient to ensure a catalyst contact time of no more than 10 milliseconds. Gas hourly space velocities (GHSV) for the process, stated as normal liters of gas per kilogram of catalyst per hour, are from about 20,000 to about 100,000,000 NL/kg/h, preferably from about 50,000 to about 50,000,000 NL/kg/h. The process preferably includes maintaining a catalyst residence time of no more than 10 milliseconds for the reactant gas mixture. The product gas mixture emerging from the reactor are harvested and may be sampled for analysis of products, including CH₄, O₂, CO, H₂ and CO₂. And, if desired, may be routed directly into a variety of applications. One such application is for producing higher molecular weight hydrocarbon components using Fisher-Tropsch technology.

Although not wishing to be bound by any particular theory, the inventors believe that the primary reaction catalyzed by the preferred catalysts described herein is the partial oxidation reaction of Equation 2, described above in the background of the invention. Other chemical reactions may also occur to a lesser extent, catalyzed by the same catalyst composition to yield a net partial oxidation reaction. For example, in the course of syngas generation, intermediates such as CO₂+H₂O may occur to a lesser extent as a result of the oxidation of methane, followed by a reforming step to produce CO and H₂. Also, particularly in the presence of carbon dioxide-containing feedstock or CO₂ intermediate, the reaction

CH₄+CO₂→2CO+2H₂ (3)

may also occur during the production of syngas. Accordingly, the term “catalytic partial oxidation” when used in the context of the present syngas production method, in addition to its usual meaning, can also refer to a net catalytic partial oxidation process, in which a light hydrocarbon, such as methane, and O₂ are supplied as reactants and the resulting product stream is predominantly the partial oxidation products CO and H₂, in a molar ratio of approximately 2:1, when methane is the hydrocarbon, rather than the complete oxidation products CO₂ and H₂O.

While the preferred embodiments of the invention have been shown and described, modifications thereof can be made by one skilled in the art without departing from the spirit and teachings of the invention. The embodiments described herein are exemplary only, and are not intended to be limiting. For example, pure methane was employed in the representative test procedures, however, any light hydrocarbon (i.e., C₁-C₅) gaseous feedstock could also serve as a feedstock for the catalytic partial oxidation reaction catalyzed by the new multi-layer monolith catalysts. Many variations and modifications of the invention disclosed herein are possible and are within the scope of the invention. For example, the heat shock resistant, thermally integrated multi-layer monoliths may also find use in catalyzing other chemical reactions in which the balancing of exothermic and endothermic reactions within the catalyst is desirable. Accordingly, the scope of protection is not limited by the description set out above, but is only limited by the claims which follow, that scope including all equivalents of the subject matter of the claims. The disclosures of all patents and publications cited herein are incorporated by reference.

What is claimed is:

1. A thermally integrated monolith catalyst active for catalyzing the oxidative conversion of methane to CO and H₂, said monolith comprising an active catalyst material supported by a multi-layer structure, said multi-layer structure comprising a stack of porous, thin metal pieces, each said piece having a top and a bottom face, a portion of at least one said face of each said piece being affixed to an opposing face of another said piece by at least one thermally conductive junction, said monolith catalyst comprising a metal oxide coating disposed between said multi-layer structure and said active catalyst material.

2. The monolith catalyst of claim 1 wherein each said piece of metal is a disk.

3. The monolith catalyst of claim 1 wherein each said at least one face comprises a periphery having at least one point of attachment.

4. The monolith catalyst of claim 1 wherein at least one said metal piece comprises at least one metal or metal oxide chosen from the group consisting of iron, nickel, cobalt, aluminum, chromium, titanium, yttrium, lanthanum, scandium, and oxides thereof.

5. The monolith catalyst of claim 4 wherein said at least one metal piece comprises an oxide-dispersion-strengthened (ODS) metal alloy.

6. The monolith catalyst of claim 5 wherein said ODS metal alloy consists of 15-25 wt % Cr, 3-6 wt % Al, 0.1-1.0 wt % Ti, 0.1-1.0 wt % Y₂O₃ and the balance Fe.

7. The monolith catalyst of claim 6 wherein said ODS alloy comprises PM2000™.

8. The monolith catalyst of claim 4 wherein at least one said metal piece comprises Cr and Al, and a metal chosen from the group consisting of Fe, Ni and Co, and combinations thereof.

9. The monolith catalyst of claim 8 wherein at least one said metal piece comprises 15-25 wt % Cr, 3-6 wt % Al, 0.1-1.0 wt % Ti, 0.3-1.0 wt % rare earth metal chosen from the group consisting of Y, La and Sc, and the balance a metal chosen from the group consisting of Fe, Ni and Co.

10. The monolith catalyst of claim 1 wherein said multi-layer structure comprises an oxidation and/or diffusion barrier coating.

11. The monolith of claim 10 wherein said coating comprises a metal oxide chosen from the group consisting of alumina, alpha-alumina, and yttrium oxide.

12. The monolith catalyst of claim 1 wherein said active catalyst material comprises at least one metal chosen from the group consisting of rhodium, nickel, cobalt, aluminum and combinations thereof.

13. The monolith catalyst of claim 1 wherein said active catalyst material comprises about 1-2% (mole % per total moles of catalyst metal content) rhodium-nickel in an atomic ratio of 1:10 (Rh:Ni).

14. The monolith catalyst of claim 1 wherein said active catalyst material comprises about 1-2% (mole % per total moles of catalyst metal content) cobalt-aluminum in an atomic ratio of 1:2 (Co:Al).

15. The monolith catalyst of claim 1 wherein said active catalyst material comprises about 2-3% (mole % per total moles of catalyst metal content) cobalt.

16. The catalyst of claim 1 wherein said active catalyst material comprises at least one metal piece comprises about 15 to 25% (mole % per total moles of catalyst metal content) chromium.

17. The catalyst of claim 1 wherein at least one said metal piece comprises about 3 to 6% (weight % per total weight of metal in said piece) aluminum.

18. The catalyst of claim 1 wherein at least one said metal piece comprises about 0.1 to 1.0% (weight % per total weight of metal in said piece) titanium.

19. The catalyst of claim 1 wherein at least one said metal piece comprises about 0.3 to 1.0% (weight % per total weight of metal in said piece) at least one rare earth element selected from the group consisting of yttrium, lanthanum, and scandium.

20. The catalyst of claim 1 wherein said the catalyst support comprises yttrium oxide in amounts ranging from 0.1 to 1.0 wt %

21. A multi-layer support for an active catalyst material, said support comprising a stack of porous, thin metal pieces, each said piece having a top and a bottom face, a portion of at least one said face of each said piece being affixed to an opposing face of another said piece by at least one thermally conductive junction.

22. The support of claim 21 wherein at least one said piece of metal is a disk.

23. The support of claim 21 wherein each said at least one face comprises a periphery having at least one point of attachment.

24. The support of claim 21 further comprising a metal oxide coating.

25. The support of claim 21 wherein at least one said metal piece comprises at least one metal or metal oxide chosen from the group consisting of iron, nickel, cobalt, aluminum, chromium, titanium, yttrium, lanthanum, scandium, and oxides thereof.

26. The support of claim 21 wherein at least one said thin metal piece comprises an oxide-dispersion-strengthened metal alloy.

27. The support of claim 26 wherein said oxide-dispersion-strengthened metal alloy consists of 15-25 wt % Cr, 3-6 wt % Al, 0.1-1.0 wt % Ti, 0.1-1.0 wt % Y₂O₃ and the balance Fe.

28. The support of claim 21 wherein said oxide-dispersion-strengthened metal alloy is PM2000™.

29. The support of claim 21 wherein at least one said metal piece comprises Cr and Al, and a metal chosen from the group consisting of Fe, Ni and Co, and combinations thereof.

30. The support of claim 21 wherein at least one said metal piece comprises 15-25 wt % Cr, 3-6 wt % Al, 0.1-1.0 wt % Ti, 0.3-1.0 wt % rare earth metal chosen from the group consisting of Y, La and Sc, and the balance a metal chosen from the group consisting of Fe, Ni and Co.

31. The support of claim 21 further comprising an oxidation and/or diffusion barrier coating.

32. The support of claim 21 wherein said coating comprises a metal oxide chosen from the group consisting of alumina, alpha-alumina, and yttrium oxide.

33. A method of making a thermally integrated monolith catalyst for catalyzing the oxidative conversion of methane to CO and H₂, said method comprising:
stacking a plurality of porous, thin flat metal pieces, each said piece having top and bottom faces and a perimeter, and comprising at least two metals or metal oxides chosen from the group consisting of iron, nickel, cobalt, aluminum, chromium, titanium, yttrium, lanthanum, scandium, and oxides thereof,
affixing together adjacent perimeters of said metal pieces to form a porous multi-layer structure of predetermined dimensions;
calcining said structure at a predetermined temperature and for a predetermined time sufficient to remove any carbon deposit from said monolith to yield a calcined structure;
preparing a solution of at least one metal salt and a solvent, the metal components of which are chosen from the group consisting of rhodium, nickel, cobalt, aluminum and combinations thereof, to form an active catalyst precursor solution;
sorbing said active catalyst precursor solution by said calcined monolith to provided an active catalyst impregnated multi-layer structure;
evaporating sorbed solvent and drying said impregnated multi-layer structure; and
calcining said impregnated multi-layer structure in air.

34. The method of claim 33 further including heating said structure at a predetermined temperature and for a predetermined time sufficient to grow a metal oxide surface coating on said structure.

35. The method of claim 33 further including heating said calcined impregnated multi-layer structure in a reducing atmosphere such the metal component of at least one said active catalyst precursor is reduced, to provide a thermally integrated monolith catalyst having catalytic activity for catalyzing the partial oxidation of methane in the presence of O₂ to CO and H₂, and having sufficient mechanical strength and thermal stress tolerance to withstand, for at least about 6 hrs, the on-stream conditions in a short contact time syngas production reactor.

36. The method of claim 34 wherein said step of heating said structure at a predetermined temperature and for a predetermined time sufficient to grow a metal oxide surface coating on said structure comprises treating said metal structure in an oxygen-containing atmosphere at a temperature of about 900-1200° C. for about 10-100 hours.

37. A method of converting a reactant gas mixture comprising a C₁-C₅ hydrocarbon and O₂ into a product gas mixture comprising CO and H₂ by a catalytic net partial oxidation reaction, the method comprising:
contacting the reactant gas mixture with the thermally integrated monolith catalyst of claim 1; and
maintaining partial oxidation reaction promoting conditions of temperature, reactant gas composition, space velocity and pressure during said contacting.

38. The method of claim 37, wherein said multi-layer structure includes a metal oxide coating disposed between each said face and said active catalyst material.

39. The method of claim 37 wherein said maintaining comprises maintaining a reactant gas/catalyst contact time of no more than about 10 milliseconds.

40. The method of claim 37 wherein said maintaining comprises maintaining a catalyst temperature of about 600 to about 1300° C.

41. The method of claim 40 comprising contacting the reactant gas mixture with the catalyst at a temperature of about 800° C. to about 1,200° C.

42. The method of claim 37 further comprising preheating the reactant gas mixture to a temperature of about 50 to about 700° C.

43. The method of claim 37 further comprising contacting the reactant gas mixture with the catalyst at a gas pressure of about 850 to about 3000 kPa.

44. The method of claim 37 wherein said maintaining comprises maintaining a process gas stream space velocity of about 20,000 to about 100,000,000 NL/kg/h.

45. The method of claim 37 wherein said maintaining comprises maintaining a process gas stream space velocity of about 50,000 to about 50,000,000 NL/kg/h.

46. The method of claim 37 wherein the C₁-C₅ hydrocarbon comprises natural gas.

47. The method of claim 37 wherein said reactant gas mixture further comprises carbon dioxide.

48. The method of claim 37 wherein the C₁-C₅ hydrocarbon comprises at least about 50% by volume methane.

49. The method of claim 48 wherein said reactant gas mixture comprises a methane to oxygen molar ratio of about 1.5:1 to about 2.2:1.

50. A method of converting a reactant gas mixture comprising a C₁-C₅ hydrocarbon and O₂ into a product gas mixture comprising CO and H₂ by a catalytic net partial oxidation reaction, the method comprising:
contacting the reactant gas mixture with a thermally integrated monolith catalyst comprising an active syngas catalyst material supported by the multi-layer structure of claim 21; and
maintaining catalytic partial oxidation reaction promoting conditions of temperature, reactant gas composition, space velocity and pressure during said contacting.

51. A method of converting a reactant gas mixture comprising a C₁-C₅ hydrocarbon and O₂ into a product gas mixture comprising CO and H₂ by a net catalytic partial oxidation reaction, the method comprising:
contacting the reactant gas mixture with a thermally integrated monolith catalyst comprising:
a catalytically active metal chosen from the group consisting of rhodium, nickel, cobalt, aluminum and combinations thereof, said metal supported by
a multi-layer structure comprising a stack of porous, thin, flat metal pieces, each said piece having a top and a bottom face, at least one said face of each said piece being affixed to an opposing face of another said piece, each said metal piece comprising, independently, at least one metal or metal oxide chosen from the group consisting of iron, nickel, cobalt, aluminum, chromium, titanium, yttrium, lanthanum, scandium, and oxides thereof, and
optionally, an oxidation and/or diffusion barrier coating said structure between said structure and said catalytically active metal; and
maintaining catalytic partial oxidation reaction promoting conditions of temperature, reactant gas composition, space velocity and pressure during said contacting, such that the reactant gas mixture/catalyst contact time does not exceed about 10 milliseconds.
